(19) United States
(12) Patent Application Publication
(10) Pub. No.: US 2006/0198984 A1
(43) Pub. Date: Sep. 7, 2006

(54) Honeycomb structure

(75) Inventor: Takashi Aoki, Nagoya-city (JP)

Correspondence Address: OLIFF & BERRIDGE, PLC, P.O. BOX 19928, ALEXANDRIA, VA, 22320, US

(73) Assignee: NGK INSULATORS, LTD., NAGOYA-CITY (JP)

(21) Appl. No.: 11/360,698

(22) Filed: Feb. 24, 2006

(30) Foreign Application Priority Data
Mar. 4, 2005 (JP) 2005-060087

(51) Int. Cl. B32B 3/12

(52) U.S. Cl. 428/116

(57) ABSTRACT

There is disclosed a honeycomb structure in which a crack due to a thermal shock is not easily generated and in which a crack is not easily developed entirely even if the crack is generated. A honeycomb structure 100 includes: partition walls 1 formed so as to define a plurality of cells 8 whose section perpendicular to an axial direction is quadrangular and which extend in an axial direction; and an outer peripheral wall 2 which surrounds the partition walls 1, and an average value (Ts) of outer peripheral wall thicknesses is Tp<Ts≦10×Tp (Tp: average value of partition wall thicknesses), and the outer peripheral wall thickness in a specific position is set to be smaller than that in another position. An average value (Tp) of partition wall thicknesses is preferably 0.038 mm≦Tp≦0.43 mm.

### BACKGROUND OF THE INVENTION

1. Field of the Invention

The present invention relates to a honeycomb structure, more particularly to a honeycomb structure which is resistant to a thermal shock and in which any crack is not easily developed entirely, even if the crack is generated.

2. Description of the Related Art

A honeycomb structure made of ceramic is used for trapping a particulate matter such as dust contained in an exhaust gas from a car, an incineration exhaust gas or the like, and further for adsorbing and absorbing NOx, CO, HC and the like from the exhaust gas by a coated substrate. Such honeycomb structure frequently undergoes a thermal shock, when heated by a high-temperature exhaust gas or the like.

To avoid a problem of thermal shock of such honeycomb structure, there is proposed a method of forming slits beforehand in an outer peripheral wall (see, e.g., Japanese Patent Application Laid-Open No. 2001-46886).

In the method described in Japanese Patent Application Laid-Open No. 2001-46886, since the slits are formed in the outer peripheral wall of the honeycomb structure during manufacturing, there is a problem that a catalyst leaks from a slit portion, when the manufactured structure carries the catalyst. The present invention has been developed in view of the above-described problems, and an object is to provide a honeycomb structure which is capable of avoiding a problem of thermal shock and in which a crack is not easily developed entirely, even if the crack is generated and whose catalyst carrying property is satisfactory.

### SUMMARY OF THE INVENTION

To achieve the above-described object, the following honeycomb structure is provided in the present invention.

[1] A honeycomb structure comprising: partition walls formed so as to define a plurality of cells extending in an axial direction; and an outer peripheral wall disposed so as to surround the partition walls, wherein an average value (Ts) of thicknesses of the outer peripheral wall satisfies the following relation: Tp<Ts≦10×Tp, wherein Tp is an average value of thicknesses of the partition walls, and the outer peripheral wall thickness in a specific position is set to be smaller than that in another position.

[2] The honeycomb structure according to [1], wherein the average value (Tp) of the partition wall thicknesses is 0.038 mm≦Tp≦0.43 mm.

[3] The honeycomb structure according to [1] or [2], wherein a section of each cell perpendicular to an axial direction has a quadrangular shape.

[4] The honeycomb structure according to any one of [1] to [3], wherein assuming that a direction extending to the outer peripheral wall from the center of the section perpendicular to the axial direction along one partition wall is a “0° direction”, and a portion of a straight line extending in the 0° direction, which crosses the outer peripheral wall, is the “outer peripheral wall in the 0° direction”, the following conditions 1 and/or 2 are satisfied:

Condition 1: a relation between a thickness (Ts₀) of the outer peripheral wall in the 0° direction and a thickness (Ts₃₀₋₆₀) of the thinnest outer peripheral wall in a region from a 30° direction to a 60° direction on the basis of the 0° direction is Tp<Ts₃₀₋₆₀<0.90×Ts₀; and

Condition 2: a relation between a thickness (Ts₉₀) of the outer peripheral wall in a 90° direction and the thickness Ts₃₀₋₆₀ is Tp<Ts₃₀₋₆₀<0.90×Ts₉₀.

[5] The honeycomb structure according to [4], wherein assuming that the region from the 0° direction (first 0° direction) to the 90° direction (first 90° direction) in the section perpendicular to the axial direction is a first region, and subsequent regions formed every 90° are second to fourth regions, respectively, at least one of the second to fourth regions satisfies the conditions 1 and/or 2.

According to the honeycomb structure of the present invention, the average value (Ts) of the outer peripheral wall thickness is Tp<Ts≦10×Tp (Tp: average value of the partition wall thicknesses), and the outer peripheral wall thickness in the specific position is set to be smaller than that in the other position. Therefore, a stress during heating or cooling is moderated by the thinly formed portion of the outer peripheral wall, and the honeycomb structure is resistant to a thermal shock. Even if a crack is generated, the crack is easily generated in the thinly formed outer peripheral wall. When the crack is generated in the thin portion of the outer peripheral wall in this manner, the crack is not easily developed to the partition walls as compared with the crack is generated in a thick portion of the outer peripheral wall. Since the outer peripheral wall does not have any missing portion such as a slit, any trouble is not caused even in a catalyst coating or the like.

### BRIEF DESCRIPTION OF THE DRAWINGS

FIG. 1 is a sectional view schematically showing a part of a section perpendicular to an axial direction of a honeycomb structure in the present invention;

FIG. 2 is a sectional view schematically showing the section perpendicular to the axial direction of the honeycomb structure in the present invention;

FIG. 3 is a perspective view schematically showing the honeycomb structure of the present invention; and

FIG. 4 is a graph showing a result of a thermal shock resistance test in an example of the honeycomb structure in the present invention.

### DESCRIPTION OF THE PREFERRED EMBODIMENT

A best mode (hereinafter referred to as the “embodiment”) for carrying out the present invention will be specifically described hereinafter, but it should be understood that the present invention is not limited to the following embodiment, and a design is appropriately changed or improved based on usual knowledge of a person skilled in the art without departing from the scope of the present invention.

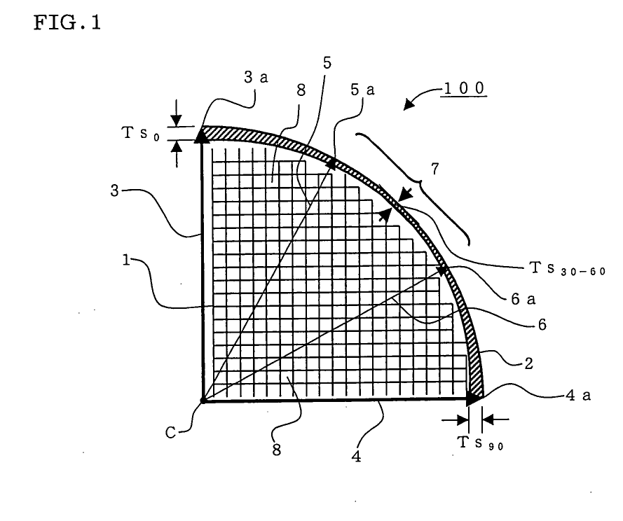

FIG. 1 is a sectional view schematically showing a part of a honeycomb structure cut along a plane perpendicular an axial direction of the structure in one embodiment of the present invention. The section cut along the plane which is perpendicular to the axial direction of the honeycomb structure will be hereinafter sometimes referred to simply as the “section perpendicular to the axial direction”. A honeycomb structure 100 of the present embodiment includes: partition walls 1 formed so as to define a plurality of cells 8 extending in an axial direction; and an outer peripheral wall 2 disposed so as to surround the partition walls 1. Furthermore, an average value (Ts) of an outer peripheral wall thickness is Tp<Ts≦10×Tp (Tp: average value of partition wall thicknesses), and the outer peripheral wall thickness in a specific position is set to be smaller than that in another position. According to such constitution, a stress during heating or cooling is moderated by the thinly formed portion of the outer peripheral wall, and the honeycomb structure is resistant to a thermal shock. Even if a crack is generated, the crack is easily generated in the thinly formed outer peripheral wall. When the crack is generated in the thin portion of the outer peripheral wall in this manner, the crack is not easily developed to the partition walls as compared with the crack is generated in a thick portion of the outer peripheral wall. Since the outer peripheral wall does not have any missing portion such as a slit, any trouble is not caused even in a catalyst carrier or the like. It is to be noted that, as shown in FIG. 1, a section of each cell 8 perpendicular to the axial direction has a quadrangular shape.

The average value (Ts) of the outer peripheral wall thicknesses is preferably Tp<Ts≦8×Tp, more preferably Tp<Ts≦6×Tp. When Ts is not more than Tp, an outer wall breaks under a stress from the outside, such as a stress due to canning. When the value is larger than 10×Tp, a thermal stress generated between the partition wall and the outer peripheral wall increases.

The average value of the outer peripheral wall thicknesses is a value obtained by measuring the outer peripheral wall thicknesses every 45° from a 0° position of the outer peripheral wall, and calculating an average of eight measurements. In a case where the section is circular, the average value of the partition wall thicknesses is obtained by calculating an average of 20 partition wall thicknesses in total including: partition wall thicknesses in ten equally divided positions of a diameter connecting the 0° position to a 180° position; and those in ten equally divided positions of a diameter connecting a 90° direction to a 270° direction. In a case where the section is elliptical, the average value is obtained by calculating an average of 20 partition wall thicknesses including: partition wall thicknesses in ten equally divided positions of a long diameter; and those in ten equally divided positions of a short diameter.

As shown in FIG. 1, assuming that a direction extending to the outer peripheral wall 2 from the center C of the section perpendicular to the axial direction along one partition wall 1 is a “0° direction”, and a portion of a straight line (0° direction line) 3 extending in the 0° direction, which crosses the outer peripheral wall 2, is an “outer peripheral wall 3a in the 0° direction”, the honeycomb structure of the present embodiment preferably satisfies the following conditions 1 and/or 2:

Condition 1: a relation between a thickness (Ts₀) of the outer peripheral wall 3a in the 0° direction and a thickness (Ts₃₀₋₆₀) of the thinnest outer peripheral wall in a region 7 (region of 30° to 60° of the outer peripheral wall) from a 30° direction to a 60° direction on the basis of the 0° direction is Tp<Ts₃₀₋₆₀<0.90×Ts₀; and

Condition 2: a relation between a thickness (Ts₉₀) of an outer peripheral wall 4a in a 90° direction and the thickness Ts₃₀₋₆₀ is Tp<Ts₃₀₋₆₀<0.90×Ts₉₀.

In this case, the thinnest outer peripheral wall in the region 7 of 30° to 60° of the outer peripheral wall corresponds to the thinly formed portion of the outer peripheral wall. This region is sometimes referred to as the thin wall region 7.

As the condition 1, 0.1×Ts₀<Ts₃₀₋₆₀<0.8×Ts₀ is further preferable, and 0.2×Ts₀<Ts₃₀₋₆₀<0.6×Ts₀ is especially preferable. As the condition 2, 0.1×Ts₉₀<Ts₃₀₋₆₀<0.8×Ts₉₀ is further preferable, and 0.2×Ts₉₀<Ts₃₀₋₆₀<0.6×Ts₉₀ is especially preferable. There is not any special restriction on a position of the thinnest portion in the region 7 of 30° to 60° of the outer peripheral wall, but a position closer to a 45° direction is preferable. A width (angle) of the thinnest portion is preferably 0° to 15°, wherein “0°” is not included.

When each cell has a square shape in the section perpendicular to the axial direction, the honeycomb structure does not easily expand or contract in a longitudinal direction (0° and 90° directions in FIG. 1) of each partition wall in the section, and the structure tends to easily expands and contracts closer to an intermediate direction (45° direction in FIG. 1). Therefore, when the honeycomb structure undergoes a thermal shock, the partition wall tends to be largely deformed closer to the intermediate direction. In a preferable mode of the honeycomb structure of the present embodiment, as described above, the thickness of the thinnest outer peripheral wall in the region (thin wall region) 7 of 30° to 60° of the outer peripheral wall is smaller than 90% of Ts₀ and/or Ts₉₀. Therefore, this thin wall region 7 is easily deformed centering on the thinnest portion as compared with another portion of the outer peripheral wall. As described above, when the partition wall is largely deformed centering on the intermediate direction, the thin wall region 7 brought into contact with the partition wall can also be deformed largely. Therefore, a stress due to the thermal shock is relaxed.

Therefore, in a case where either of the conditions 1 and 2 is not satisfied, the honeycomb structure sometimes becomes vulnerable to the thermal shock. Furthermore, if a crack is generated, the crack is sometimes easily developed to the partition wall.

In the honeycomb structure of the present embodiment, in FIG. 1, the region (region of 30° to 60° of the outer peripheral wall) 7 from the 30° direction to the 60° direction refers to an outer peripheral wall in a region from an outer peripheral wall 5a in the 30° direction as the portion of a straight line (30° direction line) 5 extending in the 30° direction, which crosses the outer peripheral wall 2, to an outer peripheral wall 6a in the 60° direction as the portion of a straight line (60° direction line) 6 extending in the 60° direction, which crosses the outer peripheral wall 2. The outer peripheral wall 4a in the 90° direction is a portion of a straight line (90° direction line) 4 extending in the 90° direction, which crosses the outer peripheral wall 2.

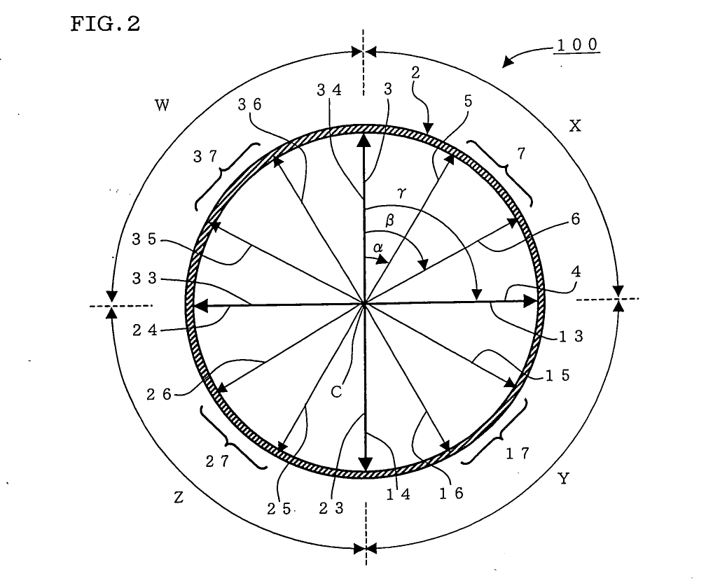

Moreover, as shown in FIG. 2, the 30° direction line 5 is a straight line which forms an angle α of 30° with respect to the 0° direction line 3, and the 60° direction line 6 is a straight line which forms an angle β of 60° with respect to the 0° direction line 3. Similarly, the 90° direction line 4 is a straight line which forms an angle γ of 90° with respect to the 0° direction line 3. The partition walls are omitted from FIG. 2.

In the honeycomb structure of the present embodiment, the average value (Tp) of the partition wall thicknesses is preferably 0.038 mm≦Tp≦0.43 mm, more preferably 0.050 mm≦Tp≦0.31 mm. When the value is smaller than 0.038 mm, a strength against canning sometimes remarkably lowers. When the value is larger than 0.43 mm, a pressure loss sometimes becomes excessively large.

In the honeycomb structure of the present embodiment shown in FIG. 2, assuming that the region from the 0° direction (first 0° direction) to the 90° direction (first 90° direction) in the section perpendicular to the axial direction is a first region X, and subsequent regions formed every 90° are a second region Y (region Y), a third region Z (region Z), and a fourth region W (region W), respectively, at least one of the second region Y to the fourth region W satisfies the conditions 1 and/or 2.

When not only the first thin wall region but also at least one of the second to fourth thin wall regions satisfy the conditions 1 and/or 2, the thin wall regions capable of exhibiting an effect of relaxing a stress due to a thermal shock increase. Therefore, the honeycomb structure of the present embodiment becomes more resistant to the thermal shock.

As shown in FIG. 2, the 90° direction line 4 in the region X is superimposed on a 0° direction line (second 0° direction line) 13 in the region Y, and a position of 90° from this second 0° direction line 13 is a second 90° direction line 14. The region Y is surrounded with the second 0° direction line 13 and the second 90° direction line 14. A position of 30° from the second 0° direction line 13 is a second 30° direction line 15, and a position of 60° from the second 0° direction line is a second 60° direction line 16. An outer peripheral wall positioned between the second 30° direction line 15 and the second 60° direction line 16 is a region (second thin wall region) 17 of the outer peripheral wall. Similarly, the region Z is a region surrounded with a third 0° direction line 23 and a third 90° direction line 24, and an outer peripheral wall positioned between a third 30° direction line 25 and a third 60° direction line 26 is a region (third thin wall region) 27 of 30° to 60° of the outer peripheral wall. Furthermore, similarly, the region W is a region surrounded with a fourth 0° direction line 33 and a fourth 90° direction line 34, and an outer peripheral wall positioned between a fourth 30° direction line 35 and a fourth 60° direction line 36 is a region (fourth thin wall region) 37 of 30° to 60° of the outer peripheral wall.

In the honeycomb structure of the present embodiment, an average value (Ts) of outer peripheral wall thicknesses is preferably 0.1 mm≦Ts≦3 mm, more preferably 0.2 mm≦Ts≦2 mm. When the value is smaller than 0.1 mm, the honeycomb structure easily breaks. When the value is larger than 3 mm, the structure is deformed, or becomes excessively heavy during manufacturing.

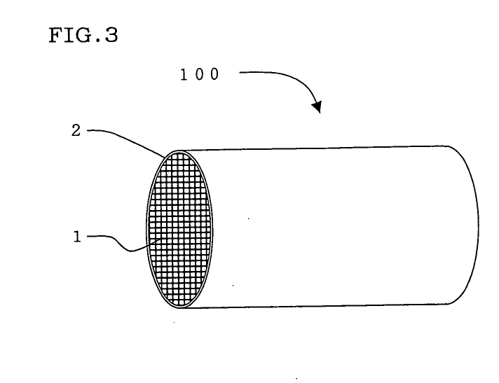

In the honeycomb structure of the present embodiment, there is not any special restriction on a shape, a size, a material or the like. In the present embodiment, as shown in FIG. 3, a honeycomb structure 100 is a columnar structure in which a plurality of cells 8 are defined by partition walls 1, and an outer peripheral wall 2 is disposed in an outer periphery of the structure so as to surround the partition walls 1. The shape is preferably columnar as shown in FIG. 3, but the shape may be a prismatic shape such as a square pole shape. As the size, in a case where the structure is, for example, columnar, the present embodiment is preferably usable in a honeycomb structure having a circle diameter of 40 to 310 mm and an axial-direction length of 10 to 310 mm. The material is preferably a ceramic, and cordierite is preferable among ceramic mat among ceramic materials. The material is preferably porous, an average pore diameter is preferably 3 to 30 μm, and a porosity is preferably 28 to 60%. The average pore diameter is a value measured by a method of “Total Pore Volume and Median Pore Diameter described in 6.3 of M505-87 Test Method of Car Exhaust Gas Purifying Catalyst Ceramic Monolith Carrier, JASO Car Standards”. The porosity is a value calculated from a pore volume. In the honeycomb structure of the present embodiment, a cell density is preferably 15 to 186 cells/cm².

Next, there will be described a method of manufacturing a honeycomb structure in the present embodiment. The honeycomb structure of the present embodiment can be obtained by: kneading predetermined forming materials to prepare a clay; forming the prepared clay to prepare a honeycomb-shaped formed body; drying the body to prepare a dried honeycomb formed body; and firing the resultant dried honeycomb formed body.

There is not any special restriction on a method of kneading the forming materials to prepare the clay, and examples of the method include a method using a kneader, a vacuum clay kneader or the like. The predetermined forming materials can be appropriately selected depending on desired materials.

There is not any special restriction on a method of preparing the honeycomb-shaped formed body, and there is usable a forming method which has been heretofore known, such as extrusion forming, injection forming, or press forming. Above all, a preferable example is a method of extruding the clay prepared as described above by use of a die having a desired outer peripheral wall thickness, a desired partition wall thickness, and a desired cell density. To manufacture the honeycomb structure of the present embodiment, the outer peripheral wall thickness in a specific position needs to be set to be smaller than that in another position. This method is as follows. That is, a supply amount of the clay to a place to be thinned is reduced by changing a back hole diameter or arrangement of the die, or a shape of a pressing plate for use in forming the outer peripheral wall. Accordingly, the specific position is formed to be thin, and a difference is made in the outer peripheral wall thickness.

There is not any special restriction on a drying method, and a drying method which has heretofore been known is usable such as hot-air drying, microwave drying, dielectric drying, reduced-pressure drying, vacuum drying, or freeze-drying. Above all, a preferable drying method is a drying method obtained by combining the hot-air drying with the microwave drying or the dielectric drying, because the whole formed body can be quickly and uniformly dried. Drying conditions can be appropriately selected in accordance with the shape, the material or the like of the honeycomb formed body.

The honeycomb formed body dried by the above method is fired in a firing furnace, so that the honeycomb structure of the present embodiment can be obtained. The firing furnace and firing conditions can be appropriately selected in accordance with the shape, the material or the like of the honeycomb formed body. Calcination may be performed before the firing to burn and remove organic matters such as a binder.

### EXAMPLES

The present invention will be described hereinafter in more detail in accordance with examples, but the present invention is not limited to these examples.

### Examples 1 to 6

Alumina, talc, and kaolin were used as forming materials. These materials were kneaded with a kneader to prepare a clay.

The resultant clay was extruded into a honeycomb shape by use of a die so as to obtain a cell structure of 3.5 mil/600 cpsi (“0.09 mm”/“93 cells/cm²”) and a honeycomb structure outer diameter of 143.8 mmφ. At this time, a honeycomb structures were formed so that “Ts₀:Ts₃₀₋₆₀” of a portion corresponding to a first region in a section perpendicular to an axial direction, and an “average outer peripheral wall thickness (average outer wall thickness)” of a honeycomb-shaped formed body were: 1:0.95 (average outer wall thickness of 0.20 mm) (Example 1); 1:0.90 (average outer wall thickness of 0.23 mm) (Example 2); 1:0.70 (average outer wall thickness of 0.26 mm) (Example 3); 1:0.60 (average outer wall thickness of 0.27 mm) (Example 4); 1:0.50 (average outer wall thickness of 0.30 mm) (Example 5); and 1:0.40 (average outer wall thickness of 0.31 mm) (Example 6). Next, the resultant honeycomb-shaped formed bodies were dried to prepare dried honeycomb formed bodies, and the resultant dried honeycomb formed bodies were fired to obtain honeycomb structures (Examples 1 to 6).

The honeycomb structures of Examples 1 to 6 were subjected to an isostatic strength test on the following conditions. Three types of samples having total lengths of 101.6 mm, 139.7 mm, and 152.4 mm were prepared as samples for the test from the honeycomb structure of each example. Results are shown in Table 1. Results indicate average values of three types of samples.

TABLE 1

| | Isostatic strength |
|---|---|
| | (kgf/cm²) |
| Example 1 | Average 38.4 |
| Example 2 | Average 46.3 |
| Example 3 | Average 38.9 |
| Example 4 | Average 50.6 |
| Example 5 | Average 62.6 |
| Example 6 | Average 52.7 |

### Examples 7 to 12

Honeycomb structures were prepared in the same manner as in Examples 1 to 6 except that a honeycomb structure outer diameter was set to 80.0 mmφ (Examples 7 to 12).

### Examples 13 to 18

Honeycomb structures were prepared in the same manner as in Examples 1 to 6 except that a honeycomb structure outer diameter was set to 90.0 mmφ (Examples 13 to 18).

### Examples 19 to 24

Honeycomb structures were prepared in the same manner as in Examples 1 to 6 except that a honeycomb structure outer diameter was set to 100.0 mmφ (Examples 19 to 24).

### Examples 25 to 30

Honeycomb structures were prepared in the same manner as in Examples 1 to 6 except that a honeycomb structure outer diameter was set to 110.0 mmφ (Examples 25 to 30).

### Examples 31 to 36

Honeycomb structures were prepared in the same manner as in Examples 1 to 6 except that a honeycomb structure outer diameter was set to 132.1 mmφ (Examples 31 to 36).

### Examples 37 to 42

Honeycomb structures were prepared in the same manner as in Examples 1 to 6 except that a cell structure was set to 2.5 mil/900 cpsi (“0.065 mm”/“140 cells/cm²”) and a honeycomb structure outer diameter was set to 76.0 mmφ (Examples 37 to 42).

### Examples 43 to 48

Honeycomb structures were prepared in the same manner as in Examples 37 to 42 except that a honeycomb structure outer diameter was set to 90.0 mmφ (Examples 43 to 48).

### Examples 49 to 54

Honeycomb structures were prepared in the same manner as in Examples 37 to 42 except that a honeycomb structure outer diameter was set to 100.0 mmφ (Examples 49 to 54).

### Examples 55 to 60

Honeycomb structures were prepared in the same manner as in Examples 37 to 42 except that a honeycomb structure outer diameter was set to 103.0 mmφ (Examples 55 to 60).

### Examples 61 to 66

Honeycomb structures were prepared in the same manner as in Examples 37 to 42 except that a honeycomb structure outer diameter was set to 105.7 mmφ (Examples 61 to 66).

### Examples 67 to 72

Honeycomb structures were prepared in the same manner as in Examples 37 to 42 except that a honeycomb structure outer diameter was set to 118.4 mmφ (Examples 67 to 72).

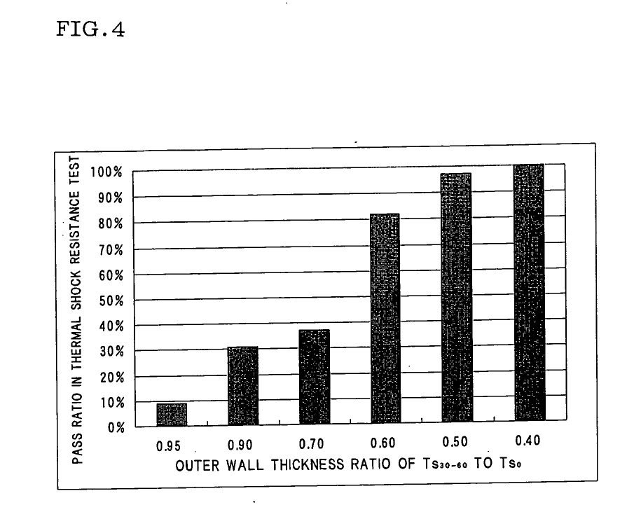

The honeycomb structures of Examples 1 to 72 were subjected to a thermal shock resistance test on the following conditions. Three types of samples having total lengths of 101.6 mm, 139.7 mm, and 152.4 mm were prepared from the honeycomb structure of each example. Results are shown in FIG. 4.

(Isostatic Strength Test)

An isostatic strength test was carried out in conformity with “Isostatic Strength Test” described in 6.2 of M505-87 in the test method of the car exhaust gas purifying catalyst ceramic monolith carrier of the JASO car standards. When an isostatic strength was 10.5 kgf/cm² (1.03 MPa) or more, it was judged that the sample passed the test.

(Thermal Shock Resistance Test)

A thermal shock resistance test was carried out in conformity with “Thermal Shock Resistance Test” described in 6.7 of M505-87 in the test method of the car exhaust gas purifying catalyst ceramic monolith carrier of the JASO car standards. When any crack was not generated, it was judged that the sample passed the test. When the crack was generated in a partition wall portion, it was judged that the sample failed. Even when the crack was generated in the outer peripheral wall, it was judged that the sample passed the test. When the outer peripheral wall crack was developed to the partition wall, it was judged that the sample failed. During the test, temperature was raised every 50° C. from 700° C., and the test was carried out up to 900° C. (with the proviso that the test was ended in a case where the sample failed halfway). A pass ratio of the thermal shock resistance test is a ratio of the number of passed samples with respect to all of the samples in a case where a “ratio of Ts₃₀₋₆₀ (outer wall thickness ratio) with respect to Ts₀” had an equal value (e.g., 0.95).

It is seen from Table 1 and FIG. 4 that the honeycomb structures of Examples 1 to 72 indicate satisfactory results in either of the isostatic strength test and the thermal shock resistance test. Especially, when Ts₀:Ts₃₀₋₆₀ were set to 1:0.60, 1:0.50, and 1:0.40, satisfactory results were obtained. This reveals that when a thickness of an outer peripheral wall in a specific position is set to be smaller than that in another position, a thermal shock resistance can be improved while maintaining an isostatic strength.

The present invention is usable for trapping a particulate matter such as dust contained in an exhaust gas from a car, an incineration exhaust gas generated during incineration of wastes or the like, and further for adsorbing and absorbing Nox, CO, HC and the like from the exhaust gas by a coated substrate.

What is claimed is:

1. A honeycomb structure comprising:
partition walls formed so as to define a plurality of cells extending in an axial direction; and
an outer peripheral wall disposed so as to surround the partition walls,
wherein an average value (Ts) of thicknesses of the outer peripheral wall satisfies the following relation:
Tp<Ts≦10×Tp, wherein Tp is an average value of thicknesses of the partition walls, and
the outer peripheral wall thickness in a specific position is set to be smaller than that in another position.

2. The honeycomb structure according to claim 1, wherein the average value (Tp) of the partition wall thicknesses is 0.038 mm≦Tp≦0.43 mm.

3. The honeycomb structure according to claim 1, wherein a section of each cell perpendicular to an axial direction has a quadrangular shape.

4. The honeycomb structure according to claim 1, wherein assuming that a direction extending to the outer peripheral wall from the center of the section perpendicular to the axial direction along one partition wall is a “0° direction”, and a portion of a straight line extending in the 0° direction, which crosses the outer peripheral wall, is the “outer peripheral wall in the 0° direction”, the following conditions 1 and/or 2 are satisfied:
Condition 1: a relation between a thickness (Ts₀) of the outer peripheral wall in the 0° direction and a thickness (Ts₃₀₋₆₀) of the thinnest outer peripheral wall in a region from a 30° direction to a 60° direction on the basis of the 0° direction is Tp<Ts₃₀₋₆₀<0.90×Ts₀; and
Condition 2: a relation between a thickness (Ts₉₀) of the outer peripheral wall in a 90° direction and the thickness Ts₃₀₋₆₀ is Tp<Ts₃₀₋₆₀<0.90×Ts₉₀.

5. The honeycomb structure according to claim 4, wherein assuming that the region from the 0° direction (first 0° direction) to the 90° direction (first 90° direction) in the section perpendicular to the axial direction is a first region, and subsequent regions formed every 90° are second to fourth regions, respectively, at least one of the second to fourth regions satisfies the conditions 1 and/or 2.
